(19) United States
(12) Patent Application Publication
(10) Pub. No.: US 2004/0172285 A1
(43) Pub. Date: Sep. 2, 2004

(54) Systems and methods for selecting drugs

(76) Inventor: Jerry Tyrone Gibson, Auburn, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/368,165

(22) Filed: Feb. 18, 2003

(51) Int. Cl. G06F 17/60

(52) U.S. Cl. 705/2

(57) ABSTRACT

An embodiment provides a method for selecting drugs, such as prescription drugs, and comprises the steps of: receiving search criteria; identifying a set of drug(s) which meet the search criteria (i.e., a relational drug class); providing identifying information about each drug in the set; receiving a selected drug from the set of drug(s); and providing basic information about the selected drug, including indications, contraindications, adverse reactions, classifications, drug interactions and/or drug class interactions.

### TECHNICAL FIELD

The present invention generally relates to drug management, and, more particularly, to systems and methods for selecting drugs, such as prescription drugs.

### DESCRIPTION OF THE RELATED ART

Health professionals rely on the labeling of drug products to provide information needed for proper use of a drug product. Because of this, the FDA requires that drug manufacturers provide extensive information with each FDA-approved drug sold in the United States. This extensive information is known as full disclosure prescription drug labeling information, or as prescription drug package insert information, and is referred to hereinafter as full disclosure labeling information.

The FDA requires the full disclosure labeling information to be in a format which includes specific section headings in a particular order. The FDA further specifies the content of information to be included under each section heading, but enables a drug manufacturer to select the style in which the content is presented, so long as the required information is provided. A manufacturer typically provides the required information in written format, supplemented with graphs, charts, and chemical formula diagrams.

When prescribing a drug, a physician often makes use of full disclosure labeling information. This information currently is available from various sources, such as the Physicians' Desk Reference®, published by the Medical Economics Company, Inc. This information is published in various formats, including print information, electronic information available on-line over the Internet, and electronic information downloadable from the Internet to hand-held personal data assistant devices.

Full disclosure labeling information is most useful when the physician knows exactly which drug is of interest and the commercial reference contains information on the drug of interest. However, this presentation is of limited usefulness to the physician who desires to determine which drug or drugs meet a combination of physician-defined criteria. Such criteria might include indications (symptoms and diagnoses for which the drug is effective), contraindications (the drug should not be prescribed for patients with these symptoms and diagnoses), and adverse reactions to the drug. Other criteria might include the drug's interactions with other drugs, classes of drugs, and diseases. The criteria could also include the classification to which a drug belongs (e.g. narcotic, antidepressant, etc.).

Therefore, to make a well-informed decision, a physician will typically review the full scope of available information from multiple sources for a variety of drugs of possible interest, make notes on the details of each, and select the drug best suited for a particular patient's situation. This can be a time-consuming and inefficient process.

### SUMMARY

Embodiments of the present invention provide systems and methods for selecting drugs, such as prescription drugs. Briefly described, in architecture, one embodiment of the system, among others, can be implemented as follows. A user interface interacts with a user to present drug information and accept drug search criteria. A query generator receives the user's search criteria and provides information about a set of drug(s) meeting the search criteria.

The present invention can also be viewed as providing methods for selecting drugs. In this regard, one embodiment of such a method, among others, can be broadly summarized by the following steps: receiving search criteria; identifying a set of drug(s) which meet the search criteria; and providing identifying information about each drug in the set.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### DESCRIPTION OF THE DRAWINGS

FIG. 1 is a flow chart illustrating an embodiment of a method for selecting a drug.

FIG. 2 is a data-flow diagram illustrating an embodiment of a system for selecting a drug.

FIG. 3 illustrates an example of a general purpose computer that can be used to implement an embodiment of a system for selecting a drug.

FIG. 4 is a block diagram illustrating one embodiment of a system for selecting a drug.

FIG. 5 is a block diagram illustrating another embodiment of a system for selecting a drug.

FIG. 6 is a block diagram illustrating yet another embodiment of a system for selecting a drug.

FIG. 7 is a diagram of the schema used by an embodiment of the drug database used by a system for selecting a drug.

FIG. 8 is an illustration of an embodiment of a user interface that can be provided by a system for selecting a drug.

FIG. 9 is a flow chart illustrating a method of selecting a drug.

FIG. 10 is a flow chart illustrating another method of selecting a drug.

### DETAILED DESCRIPTION

Systems and methods for selecting a drug are described in detail in this section. The various embodiments described here allow a user to select a drug based on a set of user-defined criteria. In one embodiment, the system uses a relational database, and the search criteria are defined in terms which correspond to database fields, for example, indications, contraindications, interactions and adverse reactions. In one embodiment, the user may combine individual search criteria with boolean logic operators (e.g. AND, OR, NOT). The set of drugs which meet this set of criteria is known as the “relational drug class.”

In one embodiment, the user-defined criteria correspond to categories which are required by the FDA to be included in a drug's full disclosure labeling information. In another embodiment, the information used to determine which drugs meet the criteria includes full disclosure labeling information. In yet another embodiment, the information used to make this determination includes other types of information, such as information provided by professional journals and/or research reports. Several exemplary embodiments will now be described with reference to the figures.

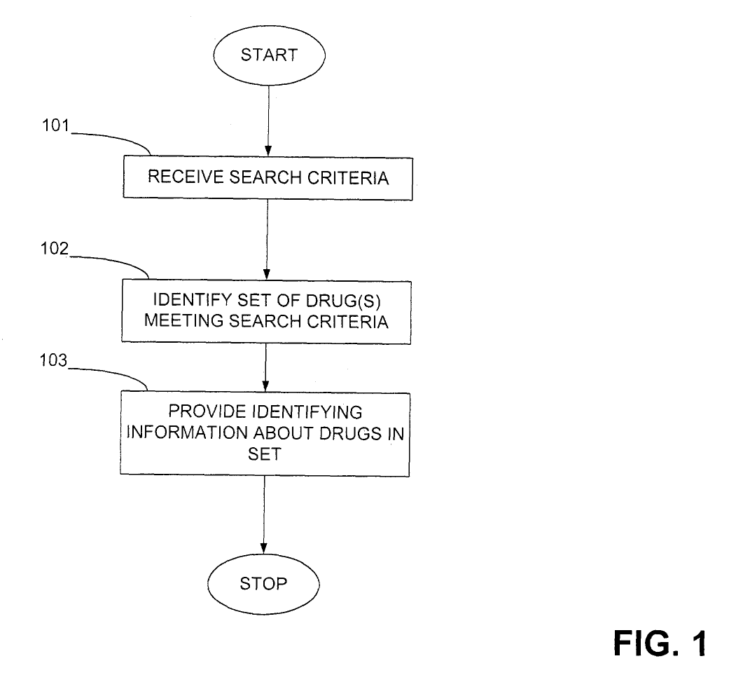

FIG. 1 is a flow chart illustrating an embodiment of a method for selecting a drug. The process begins at block 101, where the search criteria are received. In an exemplary embodiment, the criteria correspond to one or more categories used in the FDA full disclosure labeling information, e.g., indications, contraindications, adverse reactions, classification, drug interactions, or class interactions. Processing continues at block 102, where a set of at least one drug meeting the search criteria is identified. At the next block, 103, the process provides identifying information about each drug in the set, then processing completes.

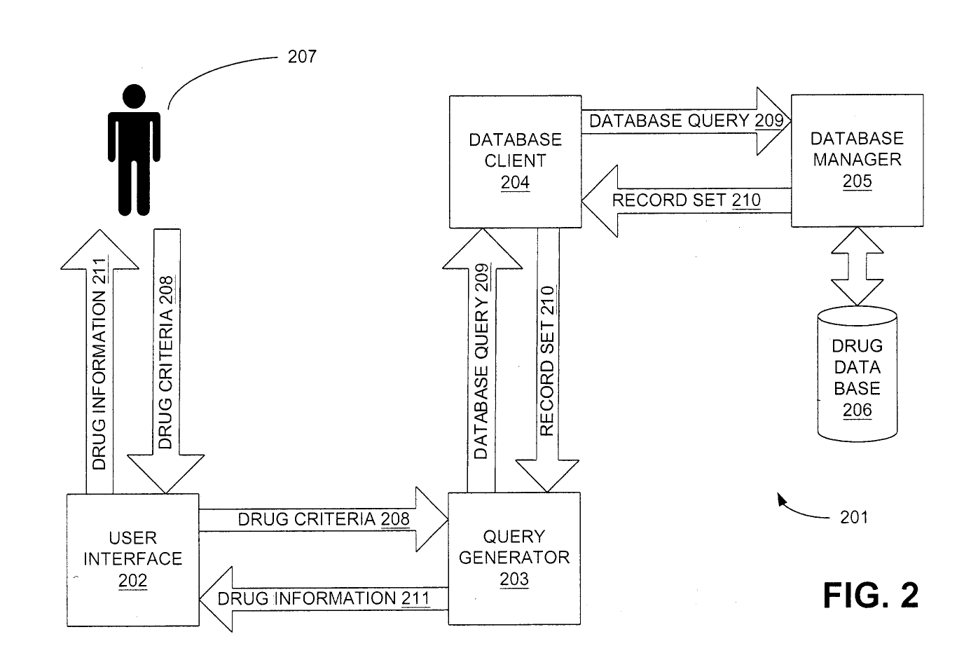

As will be described below, the process depicted in FIG. 1 can be implemented by various embodiments. By way of example, FIG. 2 is a data-flow diagram illustrating an embodiment of a system for selecting a drug 201. The embodiment of FIG. 2 includes: user interface 202; query generator 203; database client 204; database manager 205; and drug database 206. A user 207 interacts with the user interface 202 to specify a set of drug criteria 208. The user interface 202 passes drug criteria 208 on to the query generator 203, which translates the user-specified drug criteria 208 into a database query 209. The query generator 203 passes the database query 209 to the database client 204, which passes the database query 209 on to the database manager 205. The database manager 205 accesses the drug database 206 to produce a record set 210 including records which represent drugs meeting the criteria. The database manager 205 sends the record set 210 to the database client 204, which sends the record set 210 to the query generator 203. The query generator 203 processes the record set 210 and provides information 211 about drugs in the record set to the user interface 202, which presents information 211 to user 207.

In another embodiment, search critieria and search results are provided in an automated manner. Such an automated prescribing system may be integrated with a patient record database which includes information about a patient's health history, diagnoses, treatment plans, etc. The automated prescribing system extracts relevant data from a patient's record and maps the extracted data into appropriate search critieria. For example, the search critieria for a record showing a patient diagnosed with duodenal ulcer and also taking amlodipine besylate for hypertension maps to:

(Indication=dudodenal ulcer) AND NOT

(Contradindication=hypertension) AND NOT

(DrugInteraction=amolidipine besylate).

The search produces a set of drugs meeting the critieria and provides information about one or more of the drugs. In an automated system, these results are stored for later review by the physician.

Embodiments of the system for selecting a drug, such as FIG. 2, can be implemented in software (e.g., firmware), hardware, or combinations thereof. Furthermore, the components of the system can reside on one computer system, or can be distributed among more than one computer system. In some embodiments, the system for selecting a drug 201 is implemented in software, as an executable program or programs, and is executed by a special or general purpose digital computer, or combination of computers, such as a personal digital assistant or personal computer (PC).

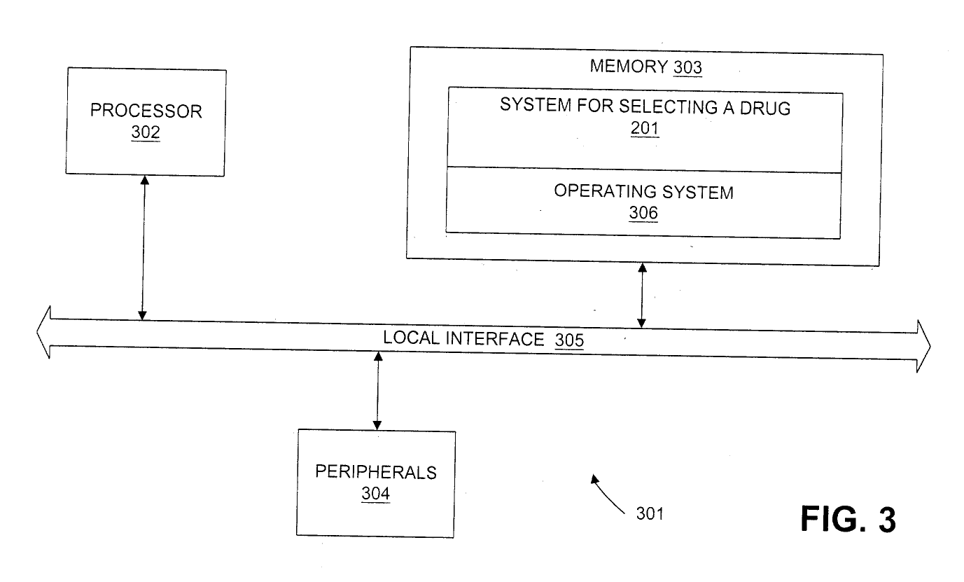

FIG. 3 illustrates an example of a general purpose computer that can be used to implement an embodiment of a system for selecting a drug, in an integrated or distributed form. Generally, in terms of hardware architecture, as shown in FIG. 3 the computer 301 includes a processor 302, memory 303, and one or more input and/or output (I/O) devices or peripherals 304 that are communicatively coupled via a local interface 305. The local interface 305 can be, for example but not limited to, one or more buses or other wired or wireless connections, as is known in the art. The local interface 305 may have additional elements (omitted for simplicity), such as controllers, buffers, drivers, repeaters, and receivers, to enable communications. Further, the local interface 305 may include address, control, and/or data connections to enable appropriate communications among the aforementioned components.

The processor 302 is a hardware device for executing software, particularly that stored in memory 303. The processor 302 can be any custom made or commercially available processor, a central processing unit (CPU), an auxiliary processor among several processors associated with the computer 301, a semiconductor based microprocessor (in the form of a microchip or chip set), a microprocessor, or generally any device for executing software instructions.

The memory 303 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 303 may incorporate electronic, magnetic, optical, and/or other types of storage media. Note that the memory 303 can have a distributed architecture, where various components are situated remote from one another, but can be accessed by the processor 302.

The software in memory 303 may include one or more separate programs, each of which comprises an ordered listing of executable instructions for implementing logical functions. In the example of FIG. 3, the software in the memory 303 includes one or more components of the system for selecting a drug 201, and a suitable operating system 306. The operating system 306 essentially controls the execution of other computer programs, such as the system for selecting a drug 201, and provides scheduling, input-output control, file and data management, memory management, and communication control and related services.

The system for selecting a drug 201 is a source program, executable program (object code), script, or any other entity comprising a set of instructions to be performed. When a source program, then the program needs to be translated via a compiler, assembler, interpreter, or the like, which may or may not be included within memory 303, so as to operate properly in connection with the operating system 306.

The peripherals 304 may include input devices, for example but not limited to, a keyboard, mouse, scanner, microphone, etc. Furthermore, the peripherals 304 may also include output devices, for example but not limited to, a printer, display, etc. Finally, the peripherals 304 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 301 is a PC, workstation, or the like, the software in the memory 303 may further include a basic input output system (BIOS) (omitted for simplicity). The BIOS is a set of essential software routines that initialize and test hardware at startup, start the operating system 306, and support the transfer of data among the hardware devices. The BIOS is stored in ROM so that the BIOS can be executed when the computer 301 is activated.

When the computer 301 is in operation, the processor 302 is configured to execute software stored within the memory 303, to communicate data to and from the memory 303, and to generally control operations of the computer 301 pursuant to the software. The system for selecting a drug 201 and the operating system 306, in whole or in part, but typically the latter, are read by the processor 302, perhaps buffered within the processor 302, and then executed.

When the system for selecting a drug 201 is implemented in software, as is shown in FIG. 3, it should be noted that the system for selecting a drug 201 can be stored on any computer readable medium for use by or in connection with any computer related system or method. In the context of this document, a “computer-readable medium” can be any means that can store, communicate, propagate, or transport the program for use by or in connection with the instruction execution system, system, or device. The computer-readable medium can be, for example but not limited to, an electronic, magnetic, optical, electromagnetic, infrared, or semiconductor system, system, device, or propagation medium. A nonexhaustive example set of the computer-readable medium would include the following: an electrical connection having one or more wires, a portable computer diskette, a random access memory (RAM), a read-only memory (ROM), an erasable programmable read-only memory (EPROM, EEPROM, or Flash memory), and a portable compact disc read-only memory (CDROM). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the system for selecting a drug 201 is implemented in hardware, the system for selecting a drug 201 can be implemented with any or a combination of the following technologies, which are each well known in the art: a discrete logic circuit(s) having logic gates for implementing logic functions upon data signals, an application specific integrated circuit(s) (ASIC) having appropriate combinatorial logic gates, a programmable gate array(s) (PGA), a field programmable gate array(s) (FPGA), etc.

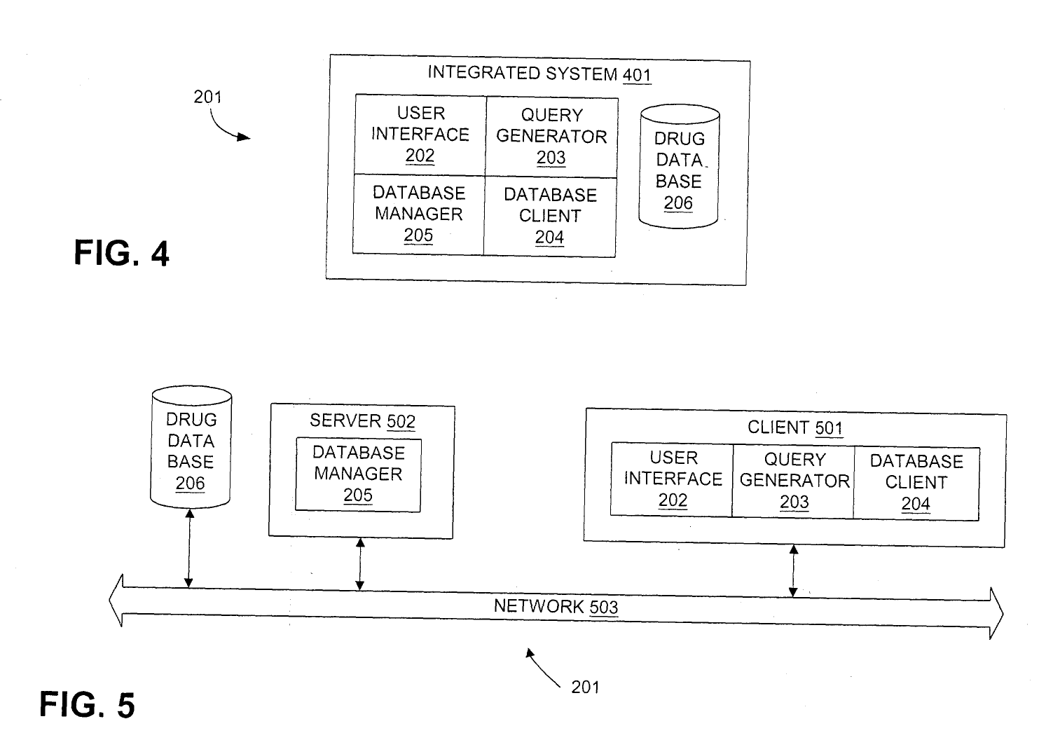

FIG. 4 is a block diagram illustrating one embodiment of a system for selecting a drug 201. In this embodiment, the user interface 202, the query generator 203, the database client 204, the database manager 205 and the drug database 206 all reside on one computer system. This single system is the integrated system 401. Suitable hardware platforms for the integrated system 401 include, but are not limited to, a personal digital assistant or other pen-computing device, a laptop or desktop personal computer, or a workstation.

FIG. 5 is a block diagram illustrating another embodiment of a system for selecting a drug 201, in which the components are distributed. In this embodiment, the user interface 202, the query generator 203 and the database client 204 reside on a client 501, while database manager 205 resides on a server 502. A network 503 allows client 501 and server 502 to communicate with each other, and allows at least server 502 to access the drug database 206. The network 503 may be a local area network, or a wide area network such as the Internet. Suitable hardware platforms for the client 501 include, but are not limited to, a personal digital assistant, a desktop or laptop personal computer, or a workstation. Suitable hardware platforms for the server 502 include, but are not limited to, a desktop or tower personal computer, a minicomputer, or a mainframe.

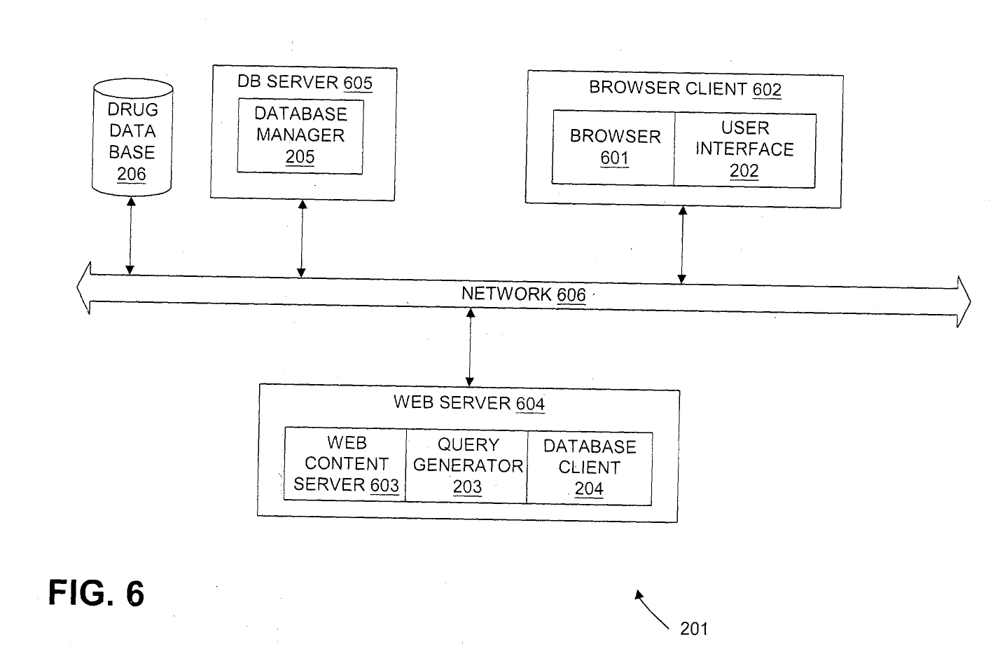

FIG. 6 is a block diagram illustrating yet another embodiment of a system for selecting a drug 201, in which the components are distributed. In this embodiment, the user interface 202 and Internet browser 601 resides on a browser client 602. The query generator 203 and the database client 204, as well as a web content server 603, reside on a web server 604. The database manager 205 resides on another system, the database server 605. A network 606 allows browser client 602 and web server 604 to communicate with each other, and allows at least database server 605 to access the drug database 206. Suitable hardware platforms for the browser client 602 include, but are not limited to, a personal digital assistant, a desktop or laptop personal computer, or a workstation. Suitable hardware platforms for the web content server 603 and database server 605 include, but are not limited to, a desktop or tower personal computer, a minicomputer, or a mainframe.

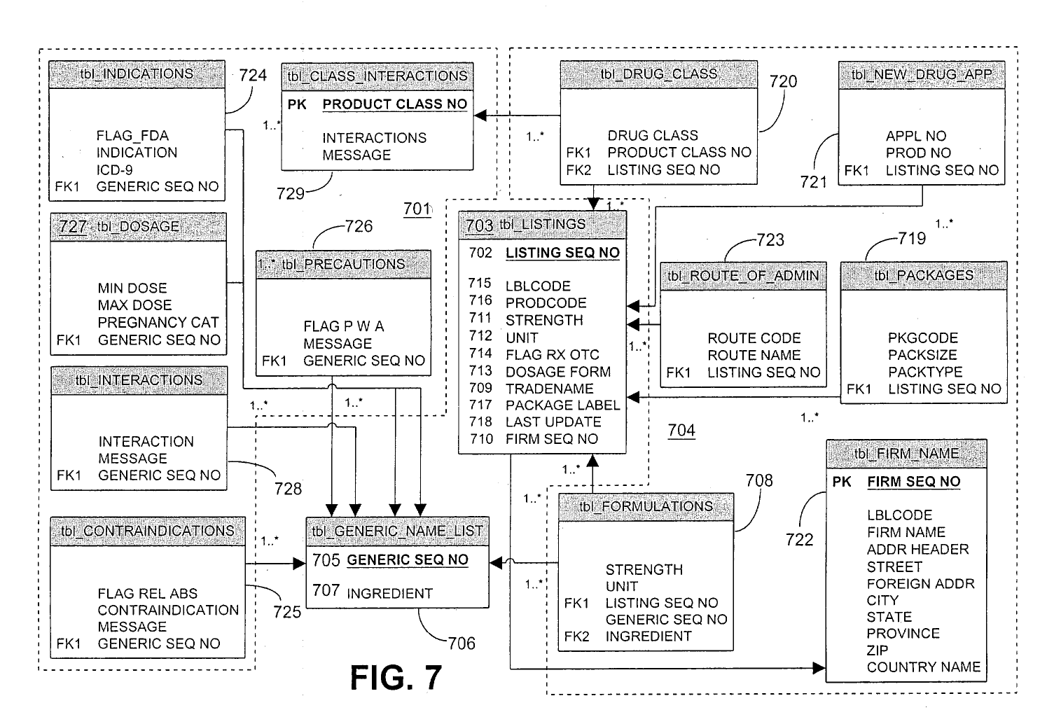

FIG. 7 is a diagram of the schema used by an embodiment of the drug database 206 used by a system for selecting a drug. This schema incorporates the organizational scheme used by the FDA's National Drug Code Directory. The drug database 206 is organized around two groups of tables. The two groups each use a different primary key, but are linked together so that data from both groups can be easily accessed.

The organizing concept for the first group, the product tables 701, is the drug product, meaning a particular formulation of one or more active ingredients labeled by a particular firm, e.g. amlodipine in 2.5 mg tablets and labeled by Bristol Meyers Squibb®. Each drug product in the drug database 206 has a unique value, assigned by the FDA, known as its LISTING SEQ NO 702. The central table in this group, tbl_LISTINGS 703, uses this LISTING SEQ NO 702 as its primary key. This central table contains various types of identifying information about each drug product. More detailed information about drug products is found in the other product tables 701 (described below), which are linked from the central products table tbl_LISTINGS 703 by primary key LISTING SEQ NO 702.

The organizing concept for the second group, the generic tables 704, is the active ingredient, also known as the generic name. Each drug product in the drug database 206 consists of one or more active ingredients, and each active ingredient has a unique value, known as its GENERIC SEQ NO 705. The central table in this group, tbl_GENERIC_NAME_LISTING 706, uses this GENERIC SEQ NO 705 as its primary key. This table contains at least the ingredient name, as field INGREDIENT 707. More detailed information about ingredients is found in the other generic tables 704, which are linked from the central table tbl_GENERIC_NAME_LISTING 706 by primary key GENERIC SEQ NO 705.

The table tbl_FORMULATIONS 708 is used to link these two groups of tables together. A drug product, identified by GENERIC SEQ NO 705, links to one or more entries in table tbl_FORMULATIONS 708, one for each active ingredient in the drug product. Each of these entries in tbl_FORMULATIONS 708, representing an active ingredient in the drug product LISTING SEQ NO 702, contains an ingredient name. This ingredient name in turn matches an entry in tbl_GENERIC_NAME_LISTING 706, which contains a GENERIC SEQ NO 705 identifying a generic. Using these linkages, a LISTING SEQ NO 702 identifying a drug product can be used to access data in the generic tables 704.

The table tbl_FORMULATIONS 708 also provides links in the other direction, so that a GENERIC SEQ NO 705 can be used to access data in the product tables 701. An active ingredient, identified by GENERIC SEQ NO 705, links to one or more entries in tbl_FORMULATIONS 708. Each of these entries in tbl_FORMULATIONS 708 represents a drug product which includes the active ingredient GENERIC SEQ NO 705. Each of these entries contains a LISTING SEQ NO 702, which can be used to access data in the product tables 701.

Data for the product tables 701 is typically derived from information made publicly available by the FDA, which is known as “on-label” data. In contrast, data for generic tables 704 typically includes “on-label” data as well as “off-label” data. Off-label data includes additional data which is not included in the full disclosure labeling information. This off-label data can be supplied by the manufacturer, or by practicing physicians and researchers through various forms of dissemination, including professional journals, research reports, formal presentations, and informal discussions.

The tables in each group are now discussed in more detail. The central table in the product tables group, tbl_LISTINGS 703, contains various forms of identifying information about a drug product, including fields: TRADENAME 709; FIRM SEQ NO 710; STRENGTH 711; UNIT 712; DOSAGE FORM 713; FLAG RX OTC 714; LBLCODE 715; and PRODCODE 716. Field TRADENAME 709 is the name of the drug product as it appears on the FDA approved label. Several fields contain identification numbers. Field FIRM SEQ NO 710 is a unique number identifying the firm which labels or manufactures the drug product. This number is typically not displayed to the user.

Field LBLCODE 715 is another unique number identifying the firm that manufactures or labels the drug, and is typically shown to the user. Field PRODCODE 716 is a unique number identifying the specific strength, dosage form and formulation of the drug. Thus, the combination of LBLCODE 715 and PRODCODE 716 identifies a particular formulation of a drug product labeled by a particular firm, e.g. 10 mg of amlodipine besylate manufactured by Pfizer®. (These two fields, LBLCODE 715 and PRODCODE 716, are the first two segments in the drug product's National Drug Code (NDC).)

The combination of fields STRENGTH 711 and UNIT 712 specifies the potency of the drug product's ingredients. For example, a value of “40” for STRENGTH 711 and “mg” for UNIT 712 specifies a drug product with 40 mg of active ingredient. Field DOSAGE FORM 713 specifies the form of the drug, for example, tablets, capsules, solution, etc. Field FLAG RX OTC 714 is a flag indicating either prescription or over-the-counter.

In this embodiment, table tbl_LISTINGS 703 contains two additional fields. The first, PACKAGE LABEL 717, contains a high-quality image of the full disclosure labeling information. The second, LAST UPDATE 718, contains the date on which the drug database 206 was last updated.

The other product tables 701, containing more detailed information about a drug product, are linked from the main table tbl_LISTINGS 703 by LISTING SEQ NO 702. Table tbl_PACKAGES 719 contains information about the one or more packages used for the drug product identified by LISTING SEQ NO 702. Table tbl_DRUG_CLASS 720 contains information about the one or more drug classes to which the drug product identified by LISTING SEQ NO 702 belongs. Table tbl_NEW_DRUG_APPLICATION 721 contains information about new FDA-approved uses for the drug product identified by LISTING SEQ NO 702. Table tbl_FIRM_NAME 722 contains information about the firm which manufactures or labels the drug product identified by LISTING SEQ NO 702. Finally, table tbl_ROUTE_OF_ADMIN 723 contains information how the drug product identified by LISTING SEQ NO 702 is administered (e.g. oral, inhalation, injection, etc.).

The second group, generic tables 704, includes the following tables: tbl_INDICATIONS 724; tbl_CONTRAINDICATIONS 725; tbl_PRECAUTIONS 726; tbl_DOSAGE 727; tbl_INTERACTIONS 728; and tbl_CLASS_INTERACTIONS 729.

The table tbl_INDICATIONS 724 contains information about indications for the drug identified by GENERIC SEQ NO 705. For each indication listed in tbl_INDICATIONS 724, the FLAG _FDA field is set to “Yes” if the indication is FDA-approved, or “No” if the indication is not FDA-approved.

The table tbl_CONTRAINDICATIONS 725 contains information about contraindications for the generic identified by GENERIC SEQ NO 705. For each contraindication in the table tbl_CONTRAINDICATIONS 725, the field FLAG REL ABS is set to either “Absolute” or “Relative,” depending on the severity of the contraindication. For example, administering ampicillin to a patient who is severely allergic to penicillin is absolutely contraindicated, while administering ampicillin to a patient who had a minor rash while taking penicillin is relatively contraindicated.

The table tbl_PRECAUTIONS 726 contains information about problems that might arise with use of the generic identified by GENERIC SEQ NO 705. For each precaution in the table tbl_PRECAUTIONS 726, the field FLAG P W A is set to “Precaution,” “Warning” or “Adverse Reaction” to indicate the type of problem.

The table tbl_DOSAGE 727 includes information about the minimum, maximum and pregancy-approved dosages of the generic identified by GENERIC SEQ NO 705.

The table tbl_INTERACTIONS 728 contains information about how the generic identified by GENERIC SEQ NO 705 interacts with other drugs.

The table tbl_CLASS_INTERACTIONS 729 contains information about how the generic identified by GENERIC SEQ NO 705 interacts with classes of drugs.

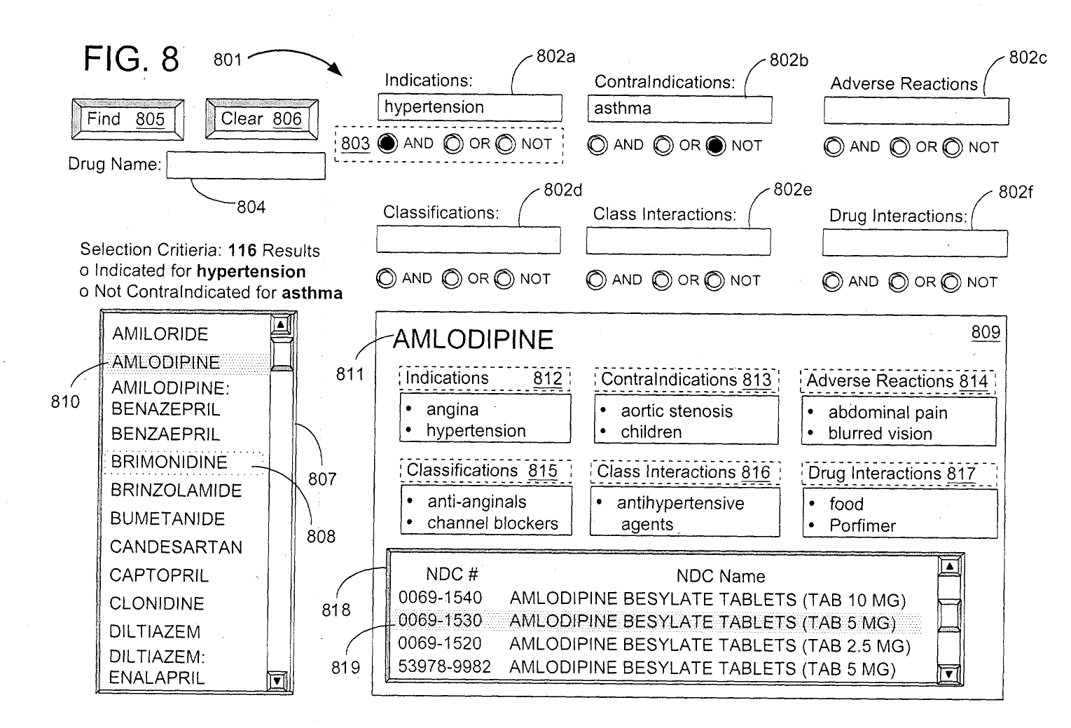

FIG. 8 is an illustration of an embodiment of a user interface that can be provided by a system for selecting a drug 201. The user interface 202 allows the user 207 to specify drug criteria 208 and to view information about drugs in record set 210. Interface 801 employs user-friendly controls to allow data selection and data entry, such as activatable buttons, list boxes, entry fields, checkboxes, and/or radio buttons. The various controls which make up interface 801 work together to present information to the user 207 and/or allow the user 207 to provide information to the system for selecting drugs meeting specified criteria.

At least one field 802 allows the user 207 to specify drug criteria 208, where each field 802 represents a field in the drug database 206. In one embodiment, the user may type into field 802. In another embodiment, the user selects from a drop-down listbox. In some embodiments, multiple fields field 802a-f allow the user to combine criteria with boolean logic operators 803 (AND, OR, NOT). In one embodiment, a field is also provided for drug name 804, allowing a search for a drug by name instead of by criteria. A “find” button 805 allows the user to initiate a search for drugs in the drug database 206 which meet the specified drug criteria 208. A “clear” button 806 allows the user to clear the criteria field 802.

A drug listbox 807 presents to the user a set of those drugs in the drug database 206 meeting the specified drug criteria 208. Each entry in the drug listbox 807 provides identifying information 808 about a drug in the set. In some embodiments, identifying information 808 is the generic name (active ingredient) of each drug. The drug listbox 807 also allows the user 207 to select a particular drug from the set. Another group of controls presents summary information 809 about the selected drug 810. Examples of summary information 809 include: generic name 811; a set of all indications 812, contraindications 813, and adverse reactions 814 associated with the selected drug 810; a set of all classifications 815 to which the selected drug 810 belongs; a set of drug classes 816 with which the selected drug 810 interacts; and a set of other drugs 817 with which the selected drug 810 interacts.

A formulations listbox 818 presents to the user 207 a set of all formulations of selected drug 810, and allows user 207 to select a particular formulation. In one embodiment, the formulation is identified to the user by NDC number, trade name, strength, and dosage form. The system then allows the user 207 to obtain the full disclosure labeling information for the selected formulation 819. In some embodiments, the user 207 is able to view full disclosure labeling information on the system display, or to print out the full disclosure labeling information, or to save the full disclosure labeling information to a file.

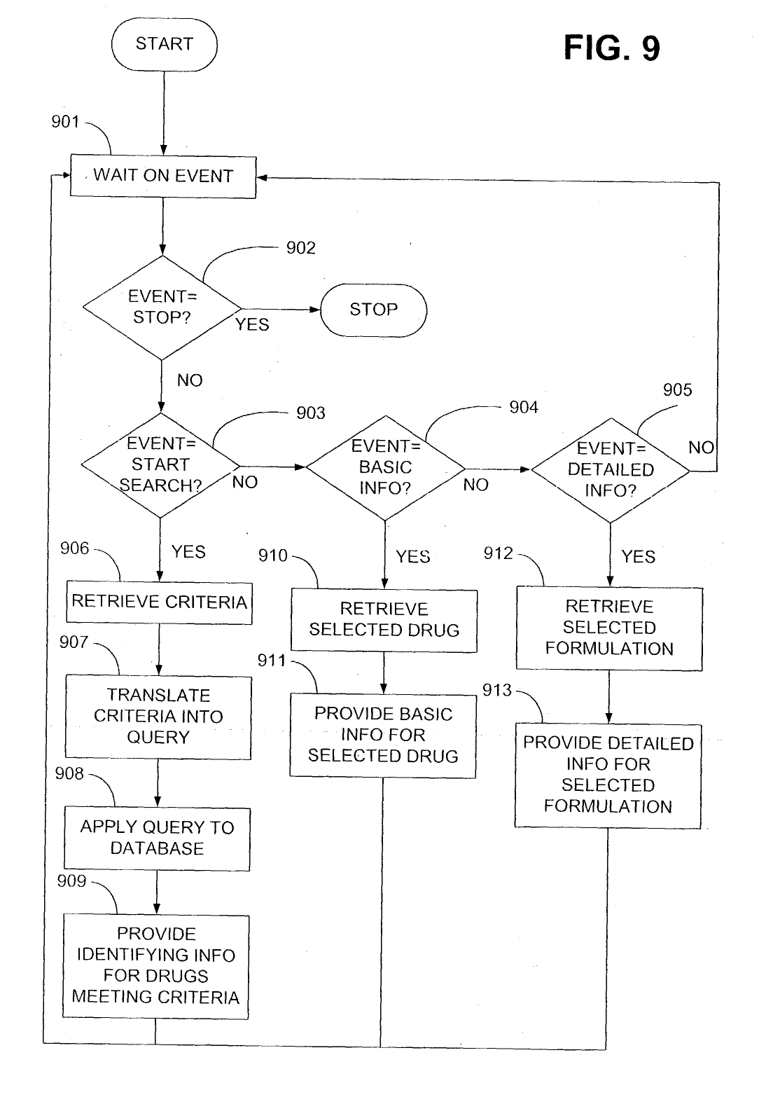

FIG. 9 is a flow chart illustrating a method for selecting a drug. The query generator 203 begins this process at block 901, where query generator 203 waits for an event from the user interface 202. Block 902 tests for a stop event, and the process then stops if the event was a stop event. Otherwise, processing continues at block 903, which tests for a Start_Search event. If the event is not Start_Search, block 904 tests for a Basic_Info event. If the event is not Basic_Info, block 905 tests for a Detailed_Info event. If the event is not Detailed_Info, the query generator 203 returns to block 901 to wait for another event.

If the event tested at block 903 was Start_Search, processing continues at block 906, which retrieves the drug criteria 208 for the search. At block 907, the query generator 203 translates the drug criteria 208 into a database query 209. At block 908, query generator 203 applies database query 209 to drug database 206 to produce record set 210 containing records for drugs meeting drug criteria 208. At block 909, the process provides identifying information for drugs in record set 210, and returns to block 901 to wait for another event.

If the event tested at block 904 was Basic_Info, processing continues at block 910, which retrieves selected drug 810. Processing continues at block 911, where the query generator 203 provides basic information for selected drug 810. The query generator 203 then returns to block 901 to wait for another event.

If the event tested at block 905 was Detailed_Info, processing continues at block 912, which retrieves selected formulation 819. Processing continues at block 913, where the query generator 203 provides detailed information for selected formulation 819. The query generator 203 then returns to block 901 to wait for another event.

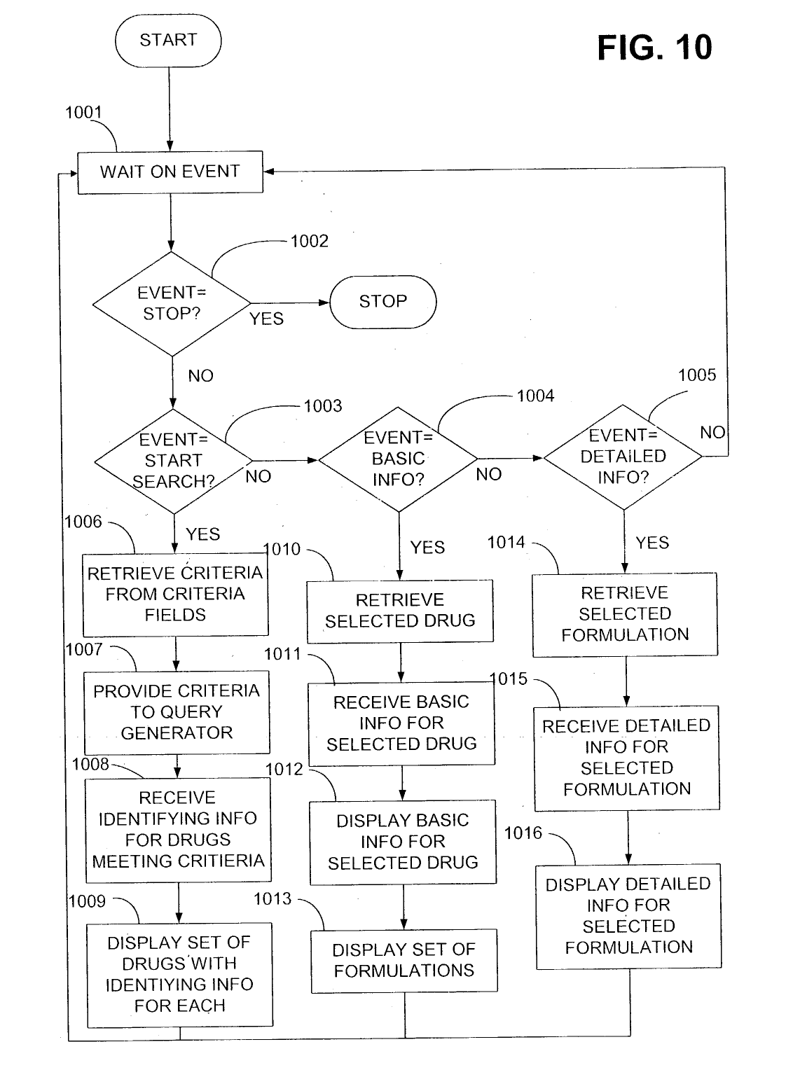

FIG. 10 is a flow chart illustrating another method of selecting a drug. The user interface 202 begins this process at block 1001, where user interface 202 waits for an event from the user 207. Block 1002 tests for a stop event, and the process then stops if the event was a stop event. Otherwise, processing continues at block 1003, which tests for a Start_Search event. If the event is not Start_Search, block 1004 tests for a Basic_Info event. If the event is not Basic_Info, block 1005 tests for a Detailed_Info event. If the event is not Detailed_Info, the user interface 202 returns to block 1001 to wait for another event.

If the event tested at block 1003 was Start_Search, processing continues at block 1006, which retrieves the drug criteria 208 for the search from field 802. At block 1007, the user interface 202 provides the drug criteria 208 to the query generator 203. At block 1008, the process receives identifying information for drugs meeting the drug criteria 208. At block 1009, the process displays a set of drugs meeting the drug criteria 208, using the identifying information. The user interface 202 then returns to block 1001 to wait for another event.

If the event tested at block 1004 was Basic_Info, processing continues at block 1010, which retrieves selected drug 810. Processing continues at block 1011, where the user interface 202 receives basic information for selected drug 810 from query generator 203. At block 1012, the process displays the basic information for selected drug 810. At block 1013, the user interface 202 displays the set of formulations for selected drug 810. The user interface 202 then returns to block 1001 to wait for another event.

If the event tested at block 1005 was Detailed_Info, processing continues at block 1014, which retrieves selected formulation 819. Processing continues at block 1015, where the user interface 202 receives detailed information for selected formulation 819. At block 1016, the process displays the detailed information for selected formulation 819, then returns to block 1001 to wait for another event.

The foregoing description has been presented for purposes of illustration and description. It is not intended to be exhaustive or to limit the invention to the precise forms disclosed. Obvious modifications or variations are possible in light of the above teachings. The embodiments discussed, however, were chosen and described to illustrate the principles of the invention and its practical application to thereby enable one of ordinary skill in the art to utilize the invention in various embodiments and with various modifications as are suited to the particular use contemplated. All such modifications and variation are within the scope of the invention as determined by the appended claims when interpreted in accordance with the breadth to which they are fairly and legally entitled.

Therefore, having thus described the invention, at least the following is claimed:

1. A method for selecting a drug, comprising:
receiving search criteria;
identifying a first set of at least one drug meeting the search criteria; and
providing identifying information about each drug in the first set of the at least one drug.

2. The method of claim 1, wherein the search criteria comprises at least one of indication, contraindication, adverse reaction, classification, drug interaction and drug class interaction.

3. The method of claim 1, further comprising:
receiving a selected drug from the first set of at least one drug; and
providing basic information about the selected drug, the basic information comprising a set of at least one of indications, contraindications, adverse reactions, classifications, drug interactions and drug class interactions.

4. The method of claim 1, wherein identifying a first set further comprises searching a drug database.

5. The method of claim 4, wherein the drug database includes off-label information.

6. The method of claim 4, wherein the drug database includes on-label information.

7. The method of claim 4, wherein the drug database is a relational database.

8. The method of claim 1, wherein providing identifying information about each drug further comprises providing a generic name.

9. The method of claim 3, further comprising:
providing a second set of at least one formulation corresponding to the selected drug;
receiving a selected formulation from the second set of at least one formulation; and
providing detailed information about the selected formulation.

10. The method of claim 9, wherein the detailed information comprises FDA full disclosure prescription labeling information.

11. The method of claim 9, wherein the at least one formulation is identified by trade name.

12. The method of claim 9, wherein the at least one formulation is identified by NDC number.

13. The method of claim 9, wherein the at least one formulation is identified by strength.

14. The method of claim 9, wherein the at least one formulation is identified by dosage form.

15. A method for presenting information about at least one drug meeting specified criteria, comprising:
receiving a search criteria from a user;
requesting a search of a drug database to produce a first set of at least one drug meeting the search criteria;
receiving identifying information about each drug in the first set;
presenting identifying information about each drug in the first set;
receiving, from the user, a first selection for a drug in the first set; and
presenting basic information about the first selection.

16. The method of claim 15, wherein the search criteria comprises at least one of indication, contraindication, adverse reaction, classification, drug interaction and drug class interaction.

17. The method of claim 15, the basic information comprising a set of at least one of indications, contraindications, adverse reactions, classifications, drug interactions and drug class interactions.

18. The method of claim 15, wherein the drug database is a relational database.

19. The method of claim 15, wherein the drug database includes off-label information.

20. The method of claim 15, further comprising:
presenting a second set of at least one formulation corresponding to the selected drug;
receiving, from the user, a second selection for a formulation in the second set of at least one formulation corresponding to the selected drug; and
providing detailed information about the second selection.

21. The method of claim 20, wherein the at least one formulation is identified by trade name.

22. The method of claim 20, wherein the at least one formulation is identified by NDC number.

23. A system for selecting a drug comprising:
a user interface, the user interface configured to present drug information to a user and to accept drug criteria from the user; and
a query generator, the query generator configured to receive the drug criteria and to provide information about a first set of at least one drug meeting the search criteria.

24. The system of claim 23, wherein the drug criteria comprises a combination of one or more of indication, contraindication, adverse reaction, classification, drug interaction and drug class interaction.

25. The system of claim 23, wherein the information about a first set of at least one drug comprises a generic name.

26. The system of claim 23, wherein the query generator is further configured to receive a selected drug from the first set and to provide additional information about the selected drug.

27. The system of claim 26, wherein the additional information comprises a second set of at least one formulation corresponding to the selected drug.

28. The system of claim 27, wherein the query generator is further configured to receive a selected formulation from the second set of at least one formulation corresponding to the selected drug and to provide detailed information about the selected formulation.

29. The system of claim 23, wherein the query generator is further configured to translate the search criteria into a database query, wherein the database query is applied to a drug database to produce the first set.

30. The system of claim 29, further comprising:
means for applying the database query to the drug database.

31. The system of claim 29, further comprising:
a database manager configured to apply the database query to the drug database.

32. The system of claim 29, further comprising:
a database client configured to receive the database query and to forward the database query to the database manager.

33. A computer readable medium having a computer program for selecting a drug, said computer readable medium comprising:
logic configured to receive search criteria;
logic configured to identify a first set of at least one drug meeting the search criteria;
logic configured to provide identifying information about each drug in the first set of the at least one drug;
logic configured to receive a selected drug from the first set of at least one drug; and
logic configured to provide basic information about the selected drug, the basic information comprising a set of at least one of indications, contraindications, adverse reactions, classifications, drug interactions and drug class interactions.
